(19) United States
(12) Patent Application Publication
(10) Pub. No.: US 2024/0394968 A1
(43) Pub. Date: Nov. 28, 2024

(54) APPARATUS FOR GENERATING 3-DIMENSIONAL OBJECT MODEL AND METHOD THEREOF

(71) Applicant: NEXTDOOR CO., LTD, Daegu (KR)

(72) Inventors: Gwang Yeul YUN, Seongnam-si (KR); Hae yoon PARK, Yongin-si (KR); Sang ki LEE, Seongnam-si (KR); Woo Li JANG, Ansan-si (KR); Myeong Hyun KIM, Seoul (KR)

(73) Assignee: NEXTDOOR CO., LTD, Daegu (KR)

(21) Appl. No.: 18/696,147

(22) PCT Filed: Jan. 20, 2022
(86) PCT No.: PCT/KR2022/001020

§ 371 Date: Mar. 27, 2024

(30) Foreign Application Priority Data
Sep. 27, 2021 (KR) 10-2021-0127251

(51) Int. Cl. G06T 17/00; G06V 10/82; G06V 40/10

(52) U.S. Cl. CPC G06T 17/00; G06V 10/82; G06V 40/10

(57) ABSTRACT

Disclosed are an apparatus for generating a 3-dimensional object model and a method thereof. An apparatus for generating a 3-dimensional object model according to some embodiments of the present disclosure can acquire two-dimensional skeleton information extracted from a two-dimensional image of a target object, convert the two-dimensional skeleton information into three-dimensional skeleton information through a deep learning module, and generate a three-dimensional model for the target object based on the converted three-dimensional skeleton information. Therefore, a three-dimensional model for a target object can be accurately generated from a two-dimensional image.

### TECHNICAL FIELD

The present disclosure relates to an apparatus for generating a 3-dimensional object model and a method thereof, and more particularly to an apparatus for generating a three-dimensional model for a target object from a two-dimensional image and a performance method of the apparatus.

### BACKGROUND ART

The posture, movement, etc. of a target object can be analyzed more precisely and accurately by using a three-dimensional model. Accordingly, attempts are being made to analyze the accuracy of user movements (e.g. swing movements, rehabilitation exercise movements) using three-dimensional models of people in fields such as golf and rehabilitation therapy. As part of this, research is being actively conducted on how to create a three-dimensional model of a person from two-dimensional images obtained by photographing person's movements.

Recently, a method of modeling a target object in three dimensions using a plurality of two-dimensional images has been proposed. The proposed method acquires a plurality of two-dimensional images by photographing a target object while rotating a camera, and synthesizes the obtained two-dimensional images to create a three-dimensional model of the target object. However, the proposed method requires multiple two-dimensional images taken at different rotation angles, making it difficult to be widely used in various fields, and has a clear limit in that a three-dimensional model cannot be created from two-dimensional images from a single viewpoint.

### RELATED ART DOCUMENT

### Patent Document

(Patent Document 1) Korean Patent No. 10-1884565 (registered on Jul. 26, 2018)

### DISCLOSURE

### Technical Problem

Therefore, the present disclosure has been made in view of the above problems, and it is one object of the present disclosure to provide an apparatus capable of accurately generating a three-dimensional model for a target object from a two-dimensional image and a method performed in the apparatus.

It is another object of the present disclosure to provide a method of accurately converting two-dimensional skeleton information into three-dimensional skeleton information.

It is yet another object of the present disclosure to provide a deep learning module capable of accurately converting two-dimensional skeleton information into three-dimensional skeleton information.

It will be understood that the technical problems of the present disclosure are not limited to the aforementioned problems and other technical problems not referred to herein will be clearly understood by those skilled in the art from disclosures below.

### Technical Solution

In accordance with an aspect of the present disclosure, the above and other objects can be accomplished by the provision of an apparatus for generating a 3-dimensional object model, the apparatus including: a memory for storing one or more instructions; and a processor configured to execute the stored instructions to perform: a motion of acquiring two-dimensional skeleton information extracted from a two-dimensional image of a target object; a motion of converting the two-dimensional skeleton information into three-dimensional skeleton information through a deep learning module; and a motion of generating a three-dimensional model for the target object based on the three-dimensional skeleton information.

In some embodiments, the deep learning module may be a Graph Convolutional Networks (GCN)-based module, and may include an encoder configured to receive the two-dimensional skeleton information and extract feature data; and a decoder configured to decode the extracted feature data and output the three-dimensional skeleton information.

In some embodiments, the processor may further include another object information other than the two-dimensional skeleton information from the two-dimensional image, and the converting motion may include a motion of inputting the two-dimensional skeleton information and the other object information into the deep learning module and acquiring the three-dimensional skeleton information.

In some embodiments, the deep learning module may be trained based on an error between three-dimensional skeleton information predicted from two-dimensional skeleton information for learning and correct answer information, and the error may include at least one of an error in a center of weight, a bone length error and a joint angle error.

In some embodiments, the deep learning module may be trained using two-dimensional skeleton information corrected based on domain information of an object, the correcting may include at least one of adding new connection lines between key points that make up a skeleton and strengthening connection lines. Here, the domain may be defined to be distinguished based on motion features of the object.

In some embodiments, the processor may further acquire other object information, other than the two-dimensional skeleton information, from the two-dimensional image, and may further perform a motion of correcting a three-dimensional model generated based on the other object information, wherein the correcting motion includes: a motion of extracting three-dimensional skeleton information from the generated three-dimensional model; a motion of correcting the extracted three-dimensional skeleton information according to the other object information; and a motion of re-generating a three-dimensional model for the target object based on the corrected three-dimensional skeleton information.

In accordance with another aspect of the present disclosure, there is provided a method of generating a 3-dimensional object model, wherein the method is performed in a computing device, and the method includes: acquiring two-dimensional skeleton information extracted from a two-dimensional image of a target object; converting the two-dimensional skeleton information into three-dimensional skeleton information through a deep learning module; and generating a three-dimensional model for the target object based on the three-dimensional skeleton information.

In accordance with yet another aspect of the present disclosure, there is provided a computer program, wherein the computer program is combined with a computing device, and stored in a computer-readable recording medium to acquire two-dimensional skeleton information extracted from a two-dimensional image of a target object; to convert the two-dimensional skeleton information into three-dimensional skeleton information through a deep learning module; and to generate a three-dimensional model for the target object based on the three-dimensional skeleton information.

### Advantageous Effects

According to some embodiments of the present disclosure described above, a three-dimensional model for a target object can be accurately generated by using various object information extracted from a two-dimensional image of the target object. For example, a three-dimensional model for the target object can be accurately generated by using the pose information, shape information, bone information, joint information, body part information, etc. of the target object. Further, the pose, motion, etc. of the target object can be more accurately analyzed through the generated three-dimensional model.

In addition, a three-dimensional model for a target object can be accurately generated from a two-dimensional image from a single viewpoint.

In addition, the two-dimensional skeleton information can be converted into three-dimensional skeleton information, and a three-dimensional model for a target object can be generated based on the three-dimensional skeleton information and object information. Accordingly, the three-dimensional model for the target object can be more accurately generated. For example, a three-dimensional model for the target object accurately can be generated through three-dimensional skeleton information even when there are some errors in two-dimensional skeleton information due to occlusion or distortion present in a two-dimensional image. In addition, a more complete 3D model can be generated by further using depth-level skeleton information even if there are few errors in two-dimensional skeleton information.

In addition, two-dimensional skeleton information can be accurately converted into three-dimensional skeleton information by using a Graph Convolutional Networks (GCN)-based conversion module suitable for graph-structured data.

In addition, the conversion accuracy of the skeleton information can be greatly improved by training a conversion module based on various errors such as an error in the center of weight, a bone length error and a joint angle error.

In addition, the conversion accuracy of skeleton information can be further improved by training a conversion module using two-dimensional skeleton information corrected by reflecting the motion features of a domain.

Further, a three-dimensional model for the target object can be more elaborately generated by correcting the three-dimensional model using object information, etc. extracted from the two-dimensional image.

It will be understood that technical effects according to the technical idea of the present disclosure are not limited to those referred to below and other non-referred technical effects will be clearly understood by those skilled in the art from disclosures below.

### DESCRIPTION OF DRAWINGS

FIG. 1 is an exemplary diagram illustrating an apparatus 1 for generating a 3-dimensional object model according to some embodiments of the present disclosure and input/output data thereof.

FIG. 2 is an exemplary flowchart schematically illustrating a method of generating a 3-dimensional object model according to a first embodiment of the present disclosure.

FIG. 3 is an exemplary diagram to further explain the method of generating a 3-dimensional object model according to the first embodiment of the present disclosure.

FIG. 4 is an exemplary diagram to explain a method of extracting two-dimensional skeleton information according to some embodiments of the present disclosure.

FIG. 5 is an exemplary flowchart schematically illustrating a method of generating a 3-dimensional object model according to a second embodiment of the present disclosure.

FIG. 6 is an exemplary diagram to further explain the method of generating a 3-dimensional object model according to the second embodiment of the present disclosure.

FIGS. 7 to 10 are exemplary diagrams to explain the structure and learning method of a conversion module according to some embodiments of the present disclosure.

FIG. 11 is an exemplary diagram to explain a method of improving the conversion accuracy of skeleton information according to a first embodiment of the present disclosure.

FIG. 12 is an exemplary diagram to explain a method of improving the conversion accuracy of skeleton information according to a second embodiment of the present disclosure.

FIG. 13 is an exemplary flowchart schematically illustrating a method of generating a 3-dimensional object model according to a third embodiment of the present disclosure.

FIG. 14 is an exemplary diagram to further explain the method of generating a 3-dimensional object model according to the third embodiment of the present disclosure.

FIG. 15 illustrates an exemplary computing device capable of implementing an apparatus for generating a 3-dimensional object model according to some embodiments of the present disclosure.

### BEST MODE

Exemplary embodiment of the present disclosure will now be described more fully with reference to the accompanying drawings, in which exemplary embodiments of the disclosure are shown. The attached drawings for illustrating exemplary embodiments of the present disclosure are referred to in order to gain a sufficient understanding of the present disclosure, the merits thereof, and the objectives accomplished by the implementation of the present disclosure. The technical idea of the disclosure may, however, be embodied in many different forms and should not be construed as being limited to the embodiments set forth herein; rather, these embodiments are provided so that the technical idea of this disclosure will be thorough and complete, and will fully convey the concept of the disclosure to one of ordinary skill in the art. The technical idea of the present disclosure is only defined by the scope of the claims

Hereinafter, the embodiments of the present disclosure will be described in detail with reference to the attached drawings. Here, when reference numerals are applied to constituents illustrated in each drawing, it should be noted that like reference numerals indicate like elements throughout the specification. In addition, in the following description of the present disclosure, a detailed description of known functions and configurations incorporated herein will be omitted when it may make the subject matter of the present disclosure unclear.

Unless defined otherwise, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein. The terms used in the present specification are used to explain a specific exemplary embodiment and not to limit the present inventive concept. Thus, the expression of singularity in the present specification includes the expression of plurality unless clearly specified otherwise in context.

In addition, when describing the components of the present disclosure, terms such as first, second, A, B, (a), and (b) can be used. These terms are only used to distinguish the component from other components, and the essence, order, or order of the component is not limited by the term. When a component is described as being “connected” or “coupled” to or “contacting” another component, that component may be directly “connected” or “coupled” to or “contacting” that component, but it should be understood that another component may be “connected,” “coupled,” or “contact” between the components.

It will be further understood that the terms “comprises” and/or “comprising,” when used in this specification, specify the presence of stated components, steps, operations, and/or elements, but do not preclude the presence or addition of one or more other components, steps, operations, and/or elements.

Hereinafter, various embodiments of the present disclosure will be described in detail with reference to the accompanying drawings.

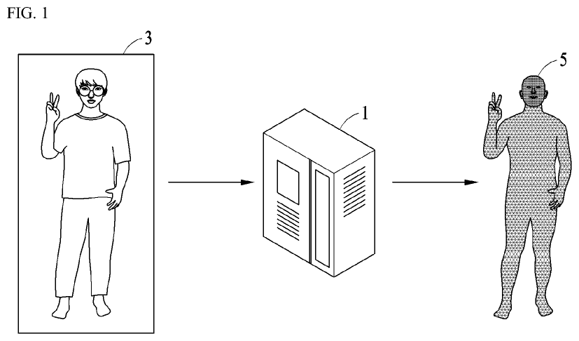

FIG. 1 is an exemplary diagram illustrating an apparatus 1 for generating a 3-dimensional object model according to some embodiments of the present disclosure and input/output data thereof.

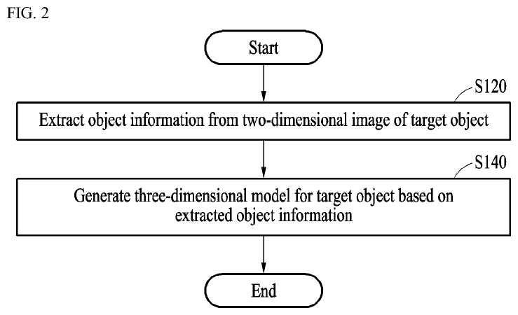

As shown in FIG. 1, an apparatus 1 for generating a 3-dimensional object model may be a computing device that receives a two-dimensional image 3 of a target object and generates and outputs a three-dimensional model 5 for the target object. For example, the apparatus 1 for generating a 3-dimensional object model may generate the three-dimensional mesh model 5 for the target object from the two-dimensional image 3 obtained by photographing the target object. A method of generating the three-dimensional model 5 by the apparatus 1 for generating a 3-dimensional object model is described in detail below with reference to the accompanying FIG. 2. Hereinafter, the apparatus 1 for generating a 3-dimensional object model is abbreviated as “generation apparatus 1” for convenience of explanation.

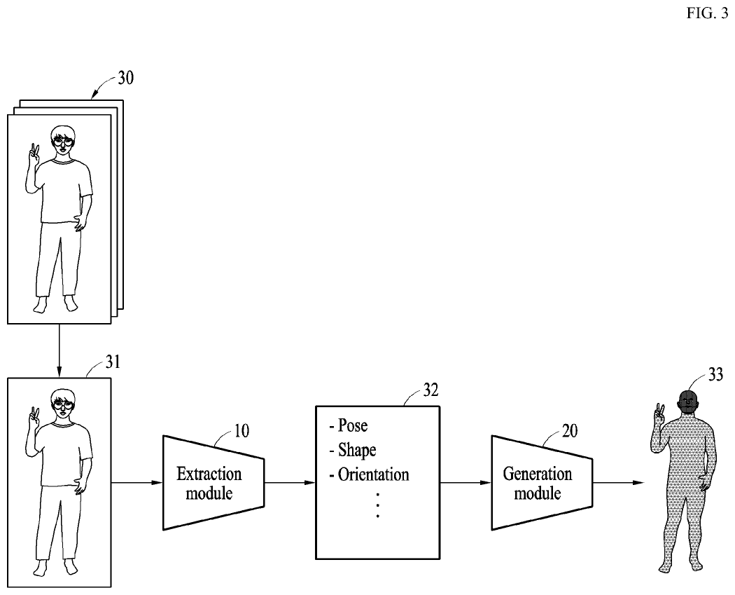

The two-dimensional image 3 is an image of a target object and may be a video image consisting of a plurality of consecutive frame images (see 30 in FIG. 3), a specific frame image, a single image, or the like. For example, the two-dimensional image 3 may be a video image acquired by filming the motion of a target object with a video camera, or an image of a specific frame that constitutes the video image.

The type of a target object may be a person as shown in the drawing, but the scope of the present disclosure is not limited thereto. A target object may be another type of object (e.g. an animal). However, to provide the convenience of understanding, the following explanation is continued assuming that the type of a target object is “person”.

The type of the three-dimensional model 5 may be a mesh model as shown in the drawing, but the scope of the present disclosure is not limited thereto. The three-dimensional model 5 may be a different type of model (e.g., voxel model). Hereinafter, for the convenience of understanding, the following description is continued assuming that the type of the three-dimensional model 5 is a “mesh model”.

In some embodiments, the generation apparatus 1 may analyze the motion of a target object using the three-dimensional model 5. Specifically, the generation apparatus 1 may continuously generate a three-dimensional model (e.g. the three-dimensional model 5), which simulates the motion of the target object, from a video image (i.e., a plurality of frame images) in which the motion of the target object is captured. In addition, the generation apparatus 1 may analyze a three-dimensional model (e.g. the three-dimensional model 5) and determine the motion of the target object more precisely and accurately. For example, the generation apparatus 1 may determine the accuracy of the motion of a human object by analyzing a three-dimensional model (e.g. the three-dimensional model 5) that simulates the motion. As a particular example, the generation apparatus 1 may determine the accuracy of exercise movements performed by a person, such as golf motions or rehabilitation exercise movements. In addition, when the accuracy is below the standard, the generation apparatus 1 may generate and provide a three-dimensional model that simulates exact exercise movements.

Meanwhile, FIG. 1 shows as an example that the generation apparatus 1 is implemented as a single computing device, but the generation apparatus 1 may be implemented as a plurality of computing devices. For example, a first function of the generation apparatus 1 may be implemented in a first computing device, and a second function thereof may be implemented in a second computing device. Alternatively, a specific function of the generation apparatus 1 may be implemented in a plurality of computing devices.

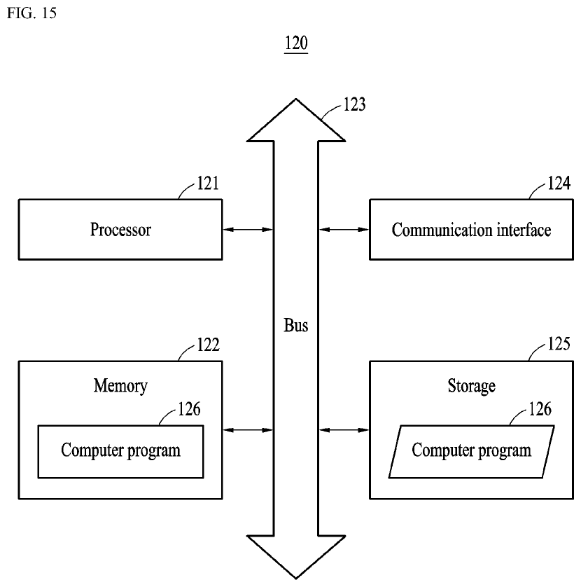

The computing device may be, for example, a laptop, desktop, etc., but is not limited thereto and may include any type of apparatus equipped with a computing function. FIG. 15 shows an example of a computing device.

The generation apparatus 1 according to some embodiments of the present disclosure and input/output data thereof have been described with reference to FIG. 1. Hereinafter, a method of generating a 3-dimensional object model by the generation apparatus 1 is described with reference to FIG. 2.

Respective steps of the method of generating a 3-dimensional object model described below may be implemented as one or more instructions that can be executed by the processor of a computing device (e.g. the computing device 1). For example, each step of the method to be described below may be implemented as one or more instructions that can be executed by the processor of the generation apparatus 1. Hereinafter, for the convenience of understanding, the description will be continued assuming that all steps of the method to be described below are performed by the generation apparatus 1 illustrated in FIG. 1. Therefore, if a subject of a specific step (motion) is omitted, it can be understood as being performed by the generation apparatus 1. In some cases, some steps of the method to be described below may be performed on another computing device.

FIG. 2 is an exemplary flowchart schematically illustrating a method of generating a 3-dimensional object model according to a first embodiment of the present disclosure. However, this is only a preferred embodiment to achieve the purpose of the present disclosure, and it is natural that some steps may be added or deleted as needed.

As shown in FIG. 2, the method according to the embodiment may begin at step S120 of extracting object information from a two-dimensional image. Specifically, the generation apparatus 1 may extract various object information 32 from a two-dimensional image 31 of a target object through an extraction module 10 as shown in FIG. 3. The two-dimensional image 31 may be, for example, one of a plurality of frame images constituting a video image 30.

The object information 32 may include, for example, pose information, shape information, orientation information, body part information, motion information, bone information, joint information, and the like, without being limited thereto.

The pose information may include, for example, information about a pose class, a two-dimensional skeleton, etc., without being limited thereto. In addition, the two-dimensional skeleton information may include, for example, two-dimensional position coordinates of key points corresponding to joints, and connection information of the key points, without being limited thereto.

In addition, the shape information may include information about the shape or volume of the entire body or part of the body, without being limited thereto.

In addition, the orientation information may include information about the direction of a target object or a camera, without being limited thereto.

In addition, the body part information may include information about the area of each body part, the center of weight, etc., without being limited thereto.

In addition, the motion information may include information about motion class, the movement speed of key points, etc., without being limited thereto.

In addition, the bone information may include information about the length and direction of the bone, etc., without being limited thereto. For example, the length of a bone may be calculated based on the distance between key points constituting a two-dimensional skeleton, without being limited thereto.

In addition, joint information may include information about a joint angle, etc., without being limited thereto. For example, the joint angle may be calculated based on the angles formed by key points constituting the two-dimensional skeleton, without being limited thereto.

The extraction module 10 is a module with an extract function for the object information 32, and may be implemented in any way. For example, the extraction module 10 may be implemented as a deep learning module based on Convolutional Neural Networks (CNN) specialized in image analysis, or as an image analysis module not based on deep learning (e.g. edge detection module, etc.).

In addition, the extraction module 10 may be composed of a plurality of modules. For example, the extraction module 10 may be configured to include a module for extracting pose information (e.g. two-dimensional skeleton information) of a target object, a module for extracting body part information, etc.

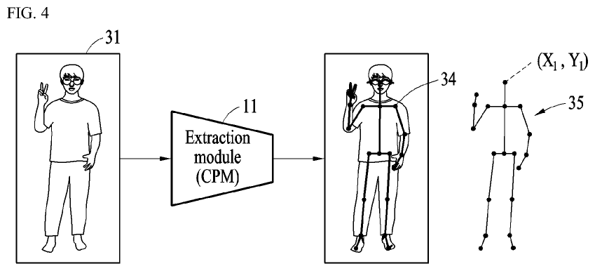

As a particular example, the extraction module 10 may include a deep learning module 11 based on Convolutional Pose Machine (CPM), and the generation apparatus 1 may extract two-dimensional skeleton information 35 by detecting a plurality of key points (e.g. 34) corresponding to joints in the two-dimensional image 31 through the deep learning module 11, as shown in FIG. 4. As described above, the two-dimensional skeleton information 35 may be information composed of the detected key points (e.g. 34) and their two-dimensional coordinates (e.g. X1, Y1). Those skilled in the art will already be familiar with the structure and operating principles of CPM, so a description thereof is omitted.

A description is made with reference to FIG. 2 again.

In step S140, a three-dimensional model for the target object may be generated based on the extracted object information. Specifically, the generation apparatus 1 may generate a three-dimensional model 33 for the target object from the object information 32 through a generation module 20, as shown in FIG. 3.

The generation module 20 is a model that generates a three-dimensional model based on the object information 32, and may be implemented in any manner. For example, the generation module 20 may be a module that generates (renders) a three-dimensional mesh model for a target object using the object information 32 as a parameter. As a particular example, when the target object is a person, the generation module 20, for example, may be a module based on Skinned Multi-Person Linear Model (SMPL), without being limited thereto. Those skilled in the art will already be familiar with SMPL, so a description thereof is omitted.

The method of generating a 3-dimensional object model according to the first embodiment of the present disclosure has been described with reference to FIGS. 2 to 4. According to the above-described method, the three-dimensional model for the target object can be accurately generated by extracting various object information such as pose information (e.g. two-dimensional skeleton information), body part information and shape information from the two-dimensional image, and using the extracted object information.

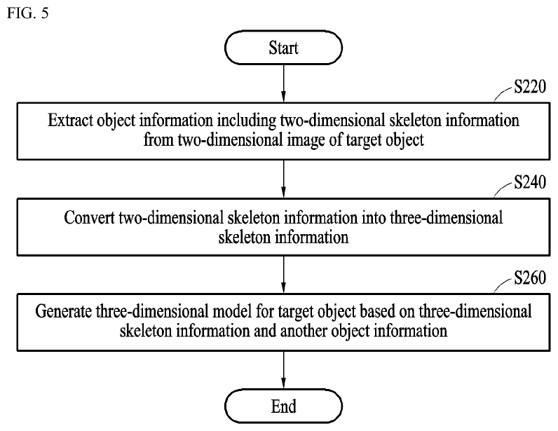

Hereinafter, a method of generating a 3-dimensional object model according to a second embodiment of the present disclosure is described with reference to FIGS. 5 to 12. For clarity of the present disclosure, a description of content that overlaps with previous embodiments is omitted.

FIG. 5 is an exemplary flowchart schematically illustrating the method of generating a 3-dimensional object model according to the second embodiment of the present disclosure. However, this is only a preferred embodiment to achieve the purpose of the present disclosure, and it is natural that some steps may be added or deleted as needed.

As shown in FIG. 5, the method according to the embodiment relates to a method of more accurately generating a three-dimensional model for a target object by converting two-dimensional skeleton information into three-dimensional skeleton information.

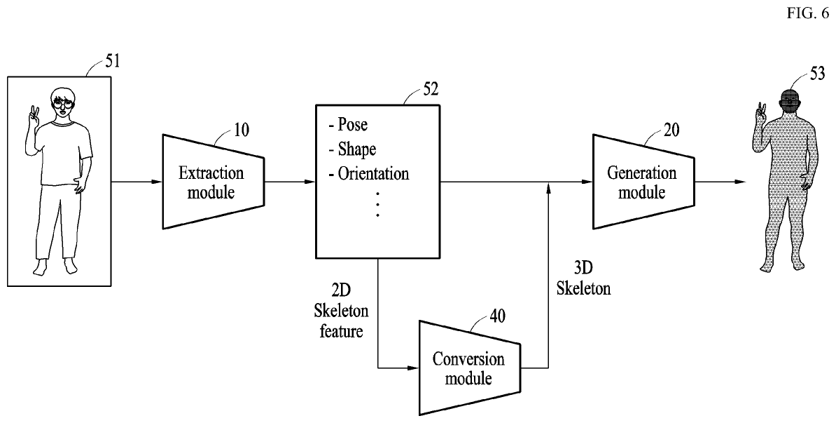

As shown in the drawing, the method according to the embodiment may also begin at step S220 of extracting object information from a two-dimensional image of a target object. Specifically, a generation apparatus 1 may extract an object information 52 from a two-dimensional image 51 through an extraction module 10 as shown in FIG. 6. Step S220 is the same as step S120 described above, so a description thereof is omitted.

In step S240, the two-dimensional skeleton information may be converted into three-dimensional skeleton information. Specifically, as shown in FIG. 6, the generation apparatus 1 may convert two-dimensional skeleton information into three-dimensional skeleton information through a conversion module 40. For example, the generation apparatus 1 may input the two-dimensional skeleton information and the object information 52 into the conversion module 40 and may acquire three-dimensional skeleton information from the conversion module 40. Here, the three-dimensional skeleton information may mean skeleton information in which the position coordinates of the key points are three-dimensional coordinates (i.e., they further include depth information).

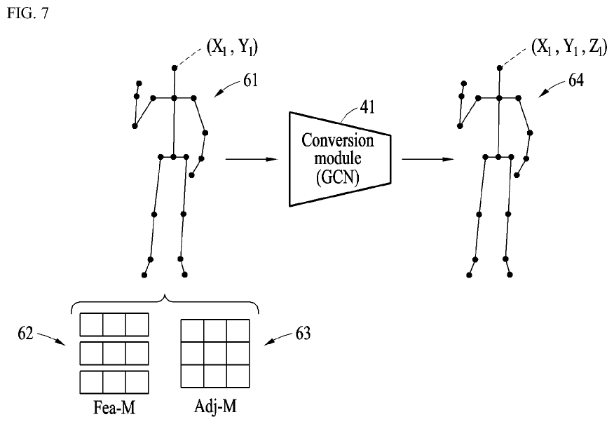

In various embodiments of the present disclosure, the conversion module 40 may be a deep learning module trained to convert two-dimensional skeleton information into three-dimensional skeleton information. The structure and learning method of the conversion module 40 are described in detail below with reference to FIGS. 7 to 12.

A description is made with reference to FIG. 5 again.

In step S260, a three-dimensional model for the target object may be generated based on the three-dimensional skeleton information and other object information. Specifically, the generation apparatus 1 may generate a three-dimensional model 53 for the target object from three-dimensional skeleton information and other object information 52 through a generation module 20, as shown in FIG. 6. In this case, the three-dimensional model 53 of the target object may be more accurately generated because the three-dimensional skeleton information can provide additional information (i.e., depth information) and errors included in the two-dimensional skeleton information can be corrected in the process of converting the two-dimensional skeleton information into three-dimensional skeleton information. For example, when there is occlusion or distortion in the two-dimensional image, some errors may be included in the two-dimensional skeleton information. This error information may be corrected in a process where the conversion module 40 reflects the object information 52 to generate three-dimensional skeleton information.

Step S260 is almost the same as step S140 described above, so further description is omitted.

Hereinafter, various embodiments related to the structure, learning method and conversion accuracy improvement method of the conversion module 40 are described with reference to FIGS. 7 to 12. For the convenience of understanding, a description is made while changing the reference number of the conversion module 40 according to the drawing.

As described above, the conversion module 40 may be a deep learning module trained to convert two-dimensional skeleton information into three-dimensional skeleton information. Specifically, the conversion module 40 may be a deep learning module trained to convert two-dimensional skeleton information into three-dimensional skeleton information in consideration of object information (i.e., object information other than two-dimensional skeleton information; feature of FIG. 6).

The conversion module 40 may be implemented with various types of deep learning modules.

In some embodiments, a conversion module 41 may be implemented as a deep learning module based on Graph Convolutional Networks (GCN), as shown in FIG. 7. In this case, the performance (i.e., conversion accuracy) of the conversion module 41 may be greatly improved. This is because two-dimensional skeleton information 61 has a graph structure and, accordingly, the features contained in the two-dimensional skeleton information 61 may be well extracted by using GCN. In addition, since object information (e.g. the object information 52) is also feature information about key points (i.e., nodes of a graph) or relationships between key points (i.e., edges of a graph) (e.g. bone information may be viewed as feature information of edges), the features necessary for information conversion may be well extracted by comprehensively considering the two-dimensional skeleton information 61 and the object information (e.g. the object information 52) by using GCN. Those skilled in the art will be sufficiently familiar with the structure and motion principles of GCN, so a detailed explanation thereof is omitted. In this embodiment, the two-dimensional skeleton information 61 may be input to the conversion module 41 in the form of an adjacency matrix (Adj-M) 63 and a feature matrix (Fea-M) 62. For example, connection information of key points may be input in the form of the adjacency matrix 63, and location coordinates of key points may be input in the form of the feature matrix 62. In addition, various object information (e.g. the object information 52) may also be input into the conversion module 41 in the form of a feature matrix (e.g. the feature matrix 62).

The detailed structure of the conversion module 40 may be designed and implemented in various ways.

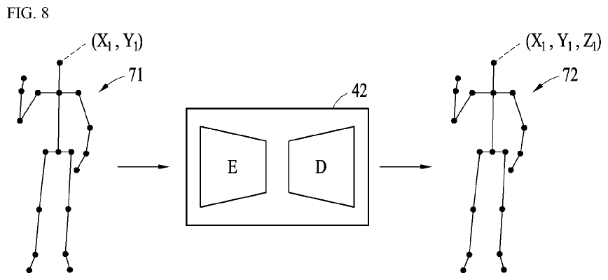

In some embodiments, a conversion module 42 may be implemented as a deep learning module having a structure including an encoder E and a decoder D as shown in FIG. 8. Examples of the deep learning module may include auto-encoder, Variational AutoEncoder (VAE), U-net, W-net, etc., but the scope of the present disclosure is not limited thereto. In this embodiment, the encoder E may extract feature data (e.g. latent vector) from two-dimensional skeleton information 71 inputted and object information (not shown), and the decoder D may output three-dimensional skeleton information 72 by decoding the extracted feature data. In addition, the encoder E and/or the decoder D may be based on GCN.

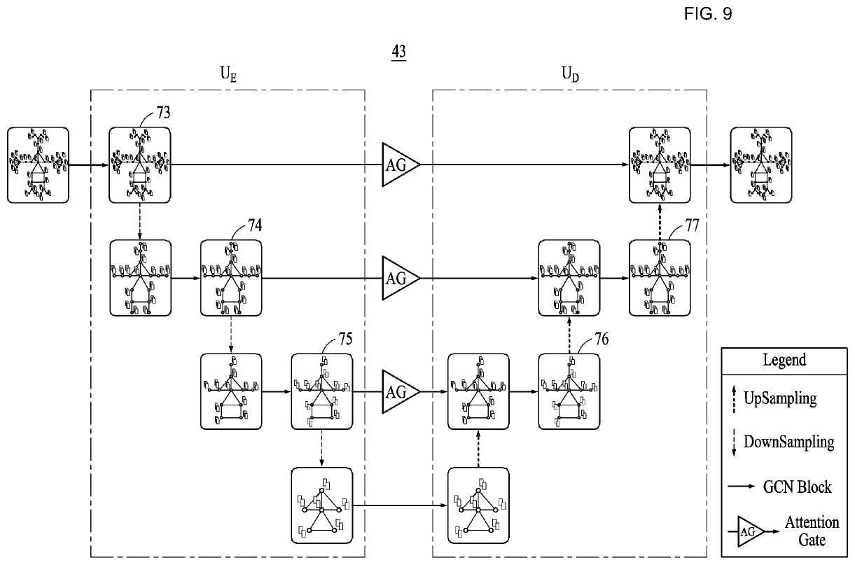

In some embodiments, the encoder UE and decoder (UD) constituting a conversion module 43 may conceptually have a U-shaped structure as shown in FIG. 9. In addition, an encoder UE and/or a decoder Up may be based on GCN. In this embodiment, the encoder UE may perform a down-sampling process on inputted two-dimensional skeleton information and object information and may extract a plurality of feature data (e.g. feature data 73 to 75) with different abstraction levels. For example, the encoder UE may repeatedly perform a graph convolution operation through a plurality of GCN blocks (layers) to continuously extract data with more intensive features (e.g. the feature data 75 contains more intensive features than the feature data 74). In addition, the decoder UD may perform an up-sampling process on the plural extracted data (e.g. the feature data 73 to 75). The conversion module 43 according to this embodiment may guarantee high conversion accuracy by utilizing feature data (e.g. the feature data 73 to 75) extracted by the encoder U_{E} and feature data (e.g. the feature data 76, 77) generated by the decoder U_{D} together. In some cases, the conversion module 43 may have a W-shaped structure wherein the U-shaped structure shown in FIG. 9 is repeatedly formed.

The conversion module 40 may be composed of one or more deep learning modules.

In some embodiments, the conversion module 40 may be composed of one deep learning module. For example, the conversion module 40 may be a deep learning module that receives two-dimensional skeleton information and various object information (e.g. bone information, joint information, body part information, etc.) and is trained to output three-dimensional skeleton information. In this case, the conversion module 40 may convert two-dimensional skeleton information into three-dimensional skeleton information by comprehensively considering various object information.

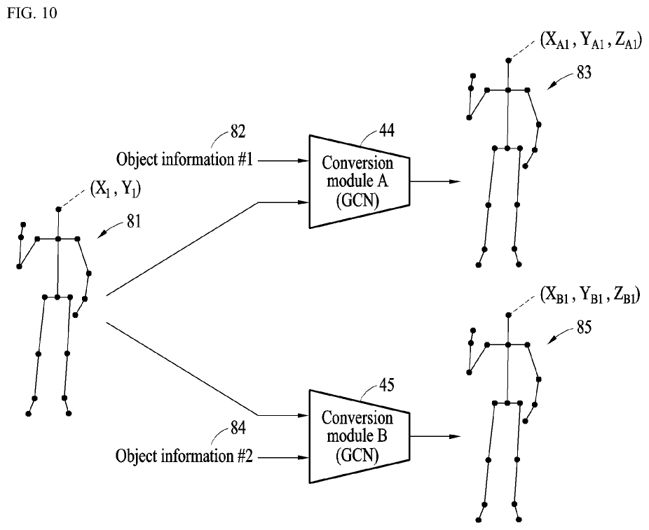

In some other embodiments, the conversion module 40 may be constituted of a plurality of deep learning modules that receive different object information. For example, as shown in FIG. 10, the conversion module 40 may be constituted to include a first deep learning module 44 and a second deep learning module 45 that receive different object information 82 and 84. Here, the first deep learning module 44 may receive two-dimensional skeleton information 81 and first object information 82 (e.g. bone information) and output first three-dimensional skeleton information 83, and the second deep learning module 45 may receive two-dimensional skeleton information 81 and second object information 84 (e.g. joint information) and output second three-dimensional skeleton information 85. In this case, the generation apparatus 1 may calculate three-dimensional skeleton information to be input to the generation module 20 by combining (e.g. averaging, etc.) the first skeleton information 83 and the second skeleton information 85. For reference, when the deep learning modules 44 and 45 are a GCN-based module, the object information 82 and 84 may be input to the deep learning modules 44 and 45 in the form of a feature matrix.

The conversion module 40 may be trained using learning data composed of two-dimensional skeleton information for learning, object information for learning and correct answer information (i.e., three-dimensional skeleton correct answer information). For example, the conversion module 40 may be trained to reduce an error between three-dimensional skeleton information (hereinafter abbreviated as “prediction information”) predicted from two-dimensional skeleton information for learning and object information for learning and correct answer information. However, the specific type of error may vary depending on an embodiment.

In some embodiments, the conversion module 40 may be trained based on an error in the center of weight. Here, the error in the center of weight may be calculated based on a difference between the center of weight calculated from prediction information and the center of weight calculated from correct answer information. Alternatively, an error in the center of weight may be calculated based on a difference between the center of weight calculated from the two-dimensional skeleton information for learning inputted to the conversion module 40 and the center of weight calculated from the prediction information. In this embodiment, the error in the center of weight may be calculated for each body part, but the scope of the present disclosure is not limited thereto. According to this embodiment, the conversion module 40 may predict three-dimensional skeleton information by further considering the center of weight of the inputted two-dimensional skeleton information.

In some embodiments, the conversion module 40 may be trained based on a bone length error. Here, the error in bone lengths may be calculated based on a difference between a bone length calculated from the prediction information and a bone length calculated from the correct answer information. As described above, the bone length may be calculated based on a distance between key points. According to this embodiment, the conversion module 40 may predict three-dimensional skeleton information by further considering the bone length according to the inputted two-dimensional skeleton information or bone information.

In some embodiments, the conversion module 40 may be trained based on an error in joint angles. Here, the joint angle error may be calculated based on a joint angle calculated from the prediction information and a joint angle calculated from the correct answer information. According to this embodiment, the conversion module 40 may predict three-dimensional skeleton information by further considering the joint angle according to the inputted two-dimensional skeleton information or joint information.

In some embodiments, the conversion module 40 may be trained based on a symmetry error. For example, a two-dimensional skeleton for learning inputted to the conversion module 40 has a symmetrical structure (e.g. vertical symmetry, left and right symmetry), the conversion module 40 may be trained to reduce errors based on the degree of symmetry of the predicted three-dimensional skeleton. According to this embodiment, the conversion accuracy for the two-dimensional skeleton having a symmetrical structure may be further improved.

In some embodiments, the conversion module 40 may be trained based on a projection error. Here, the projection error may be calculated based on a difference between two-dimensional skeleton information generated from prediction information through a projection operation and two-dimensional skeleton information for learning inputted to the conversion module 40. According to this embodiment, the performance of the conversion module 40 may be further improved by further training the projection error.

In some embodiments, the conversion module 40 may be trained based on a combination of the above-described various embodiments.

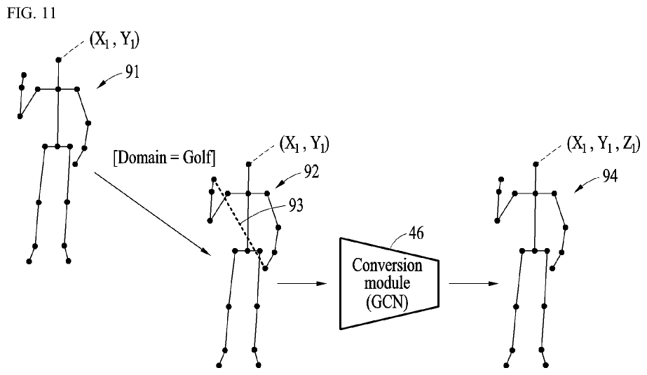

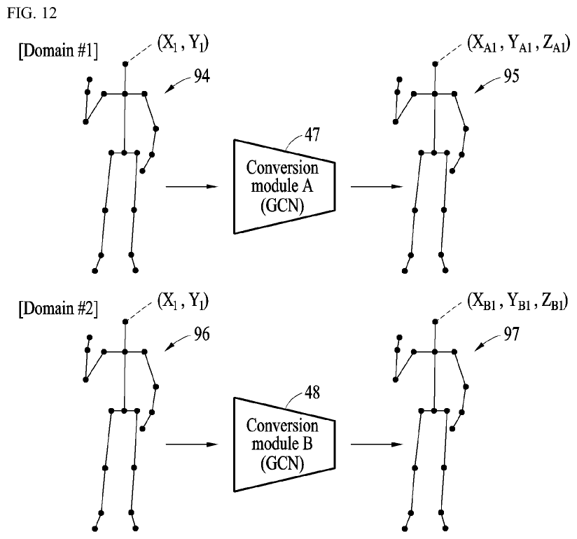

Hereinafter, a method of further improving the conversion accuracy of skeleton information is described with reference to FIGS. 11 and 12.

First, a method of improving the conversion accuracy of skeleton information according to a first embodiment of the present disclosure is described with reference to FIG. 11.

As shown in FIG. 11, this embodiment relates to a method of improving the conversion accuracy of skeleton information by training a conversion module 46 using two-dimensional skeleton information 91 corrected using the motion features of a domain.

Specifically, a domain of a target object may be defined to be distinguished based on the motion features of the target object. In other words, objects that share common motion features may belong to the same domain. For example, a domain of a target object may be divided into soccer (i.e., an object related to soccer movements), golf, rehabilitation treatment, etc. As another embodiment, a domain of a target object may be divided into foot motions (i.e., an object related to foot motions), hand motions, etc. As still another embodiment, the domain of a target object may be defined in a more detailed form, such as a first motion related to golf, a second motion related to golf, etc.

In the above case, two-dimensional skeleton information 91 for learning may be corrected based on the motion features of the domain. In addition, the performance of the conversion module 46 may be improved by training the conversion module 46 using the corrected two-dimensional skeleton information 92. Here, the correcting of the two-dimensional skeleton information 91 may include, for example, adding a new connection line between key points that make up the skeleton, strengthening the connection line (e.g. amplifying the adjacency matrix value representing the connection line), etc., but the scope of the present disclosure is not limited thereto.

For example, the domain of a target object is assumed to be a golf as shown in the drawing. Then, since both hands are frequently used due to the nature of golf motions, a new connection line 93 may be added between key points corresponding to both hands in the two-dimensional skeleton information 91, or the connection line of key points corresponding to the hands may be strengthened. In addition, the conversion module 46 may be trained using the corrected two-dimensional skeleton information 92. In this case, since the conversion module 46 predicts three-dimensional skeleton information 94 by further focusing on body parts related to motions in the golf domain, the performance of the conversion module 46 (i.e., conversion accuracy of skeleton information) may be greatly improved.

As another embodiment, the domain of the target object is assumed to be soccer. Then, since the feet are frequently used due to the nature of soccer motions, correction may be performed by adding a new connection line between key points corresponding to both feet in the two-dimensional skeleton information or strengthening the connection line of key points corresponding to the foot area.

For reference, also in the process of converting the two-dimensional skeleton information into three-dimensional skeleton information using the trained conversion module 46, the two-dimensional skeleton information may be corrected based on the domain information of the target object, and the corrected two-dimensional skeleton information may be input into the conversion module 46.

Hereinafter, a method of improving the conversion accuracy of skeleton information according to a second embodiment of the present disclosure is described with reference to FIG. 12.

As shown in FIG. 12, this embodiment relates to a method of improving the conversion accuracy of skeleton information by building a conversion module 47 or 48 for each domain of a target object.

For example, a first conversion module 47 may be built by training learning data belonging to a first domain, and a second conversion module 48 may be built by training learning data belonging to a second domain. In this case, the first conversion module 47 may convert inputted two-dimensional skeleton information 94 into three-dimensional skeleton information 95 reflecting the features (e.g. motion features) of the first domain, and the second conversion module 48 may convert inputted two-dimensional skeleton information 96 into three-dimensional skeleton information 97 reflecting the features of the second domain.

In this embodiment, the generation apparatus 1 may determine a conversion module corresponding to the domain of the target object from among a plurality of conversion modules 47 and 48, and may convert the two-dimensional skeleton information into three-dimensional skeleton information through the determined conversion module.

Hereinafter, a method of improving the conversion accuracy of skeleton information according to a third embodiment of the present disclosure is described.

This embodiment relates to a method of improving the conversion accuracy of skeleton information by training a conversion module 40 with learning data including domain information.

Specifically, the conversion module 40 may be trained using learning data composed of two-dimensional skeleton information for learning, object information, domain information and correct answer information. For example, two-dimensional skeleton information for learning, object information and domain information may be input to the conversion module 40, and the conversion module 40 may be trained to reduce an error between three-dimensional skeleton information predicted by the conversion module 40 and correct answer information. In this case, the conversion module 40 may reflect the domain features (e.g. motion features) of the target object and convert the two-dimensional skeleton information into three-dimensional skeleton information.

For reference, the domain information of the target object may be input into the conversion module 40 also in the process of converting the two-dimensional skeleton information into three-dimensional skeleton information using the trained conversion module 40.

Hereinafter, a method of improving the conversion accuracy of skeleton information according to a fourth embodiment of the present disclosure is described.

This embodiment relates to a method of improving the conversion accuracy of skeleton information by training the conversion module 40 using the two-dimensional skeleton information corrected based on the movement speed of key points constituting the skeleton.

Specifically, when the two-dimensional image of the target object is composed of a plurality of consecutive frame images, the movement speed of key points may be extracted together with the two-dimensional skeleton information. In addition, the conversion module 40 may be trained using two-dimensional skeleton information for learning generated by correcting (e.g. adding a new connection line, strengthening the connection line) a connection line between key points whose movement speed is greater than a reference value. In this case, since the conversion module 40 may predict three-dimensional skeleton information by focusing on a body part with a relatively large movement, the conversion accuracy of skeleton information may be improved.

For reference, also in the process of converting the two-dimensional skeleton information into three-dimensional skeleton information using the trained conversion module 40, the two-dimensional skeleton information may be corrected based on the movement speed of key points, and the corrected two-dimensional skeleton information may be input into the conversion module 40.

The method of generating a 3-dimensional object model according to the second embodiment of the present disclosure has been described with reference to FIGS. 5 to 12. According to the above-described method, the two-dimensional skeleton information may be converted into three-dimensional skeleton information through the conversion module 40, and a three-dimensional model may be generated based on the three-dimensional skeleton information and the object information. Accordingly, the three-dimensional model for the target object may be more accurately generated. For example, the three-dimensional model for the target object may be accurately generated even when there are some errors in the two-dimensional skeleton information due to occlusion or distortion present in the two-dimensional image. In addition, even if there are few errors in the two-dimensional skeleton information, a more complete three-dimensional model may be generated by further providing depth-level skeleton information to the generation module 20.

In addition, the two-dimensional skeleton information may be accurately converted into three-dimensional skeleton information by using a GCN-based conversion module suitable for graph-structured data.

In addition, the conversion accuracy of the skeleton information may be greatly improved by training the conversion module based on various errors such as an error in the center of weight, a bone length error and an error in joint angles.

In addition, the conversion accuracy of the skeleton information may be further improved by reflecting the motion features of the domain to correct the two-dimensional skeleton information and by training the conversion module using the corrected two-dimensional skeleton information.

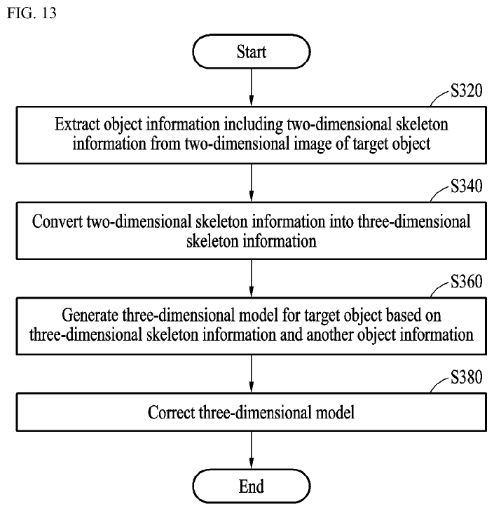

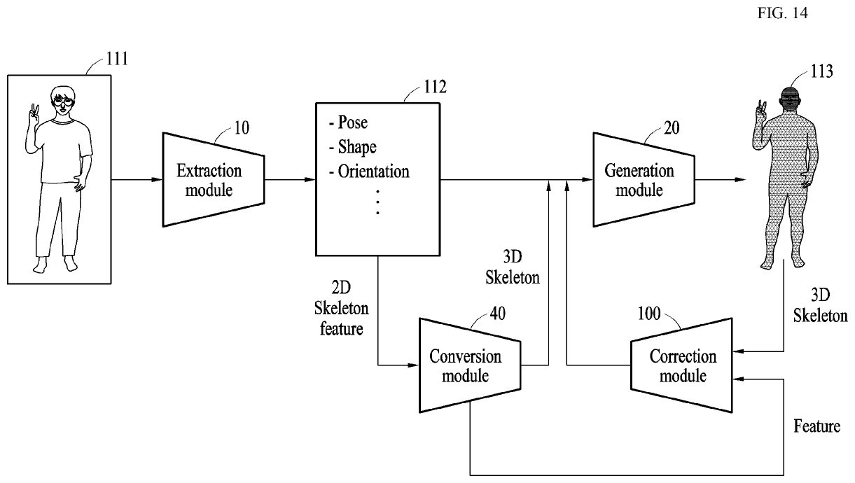

Hereinafter, a method of generating a 3-dimensional object model according to a third embodiment of the present disclosure is described with reference to FIGS. 13 and 14. For clarity of the present disclosure, a description of content that overlaps with previous embodiments is omitted.

FIG. 13 is an exemplary flowchart schematically illustrating a method of generating a 3-dimensional object model according to a third embodiment of the present disclosure. However, this is only a preferred embodiment to achieve the purpose of the present disclosure, and it is natural that some steps may be added or deleted as needed.

As shown in FIG. 13, the method according to the embodiment relates to a method of more accurately generating a three-dimensional model for a target object by correcting a three-dimensional model using object information extracted from a two-dimensional image.

Steps S320 to S360 are respectively the same as the steps S220 to S260 described above, so a description thereof is omitted.

In step S380, the three-dimensional model for the target object may be corrected. However, a specific correction method may vary depending on an embodiment.

In some embodiments, a three-dimensional model 113 may be corrected based on object information 112 (e.g. two-dimensional skeleton information, bone information, joint information) extracted from a two-dimensional image 111 as shown in FIG. 14. Specifically, the generation apparatus 1 may extract three-dimensional skeleton information from the three-dimensional model 113, and may correct the three-dimensional skeleton information through a correction module 100. In addition, the generation apparatus 1 may provide the corrected three-dimensional skeleton information and object information 112 to the generation module 20 to re-generate a three-dimensional model for the target object 113. In this embodiment, the correction module 100 may perform a function of correcting the inputted three-dimensional skeleton information to match the inputted object information. According to this embodiment, the accuracy of the three-dimensional model 113 may be further improved by correcting the three-dimensional model 113 to match the object information 112 extracted from the two-dimensional image 111. To elaborate, since the object information 112 is information extracted directly from the two-dimensional image 111, it has relatively high accuracy. However, since the object information 112 is mostly two-dimensional information, errors may occur in a process where the generation module 20 generates the three-dimensional model 113 based on the object information 112. Accordingly, when the process of correcting the three-dimensional model 113 to match the object information 112 is further performed, the error of the generation module 20 may be minimized, so a more elaborate three-dimensional model 113 may be generated.

In the above embodiments, the correction module 100 may be implemented as a deep learning module or may be implemented as another type of module. For example, the correction module 100 may be implemented as a deep learning module trained to receive the three-dimensional skeleton information and the object information 112 and to output the corrected three-dimensional skeleton information. The correction module 100 may have the same as or similar structure to the above-described conversion module 40 and may be implemented by being trained in the same or similar manner. As another embodiment, the correction module 100 may be implemented as a module that performs a predetermined correction logic on the three-dimensional skeleton information inputted according to the object information 112.

In some other embodiments, the three-dimensional model (e.g. the three-dimensional model 113) may be corrected based on the three-dimensional object information (e.g. three-dimensional skeleton information, three-dimensional bone information, three-dimensional joint information, three-dimensional body part information, etc.) extracted from a three-dimensional model (e.g. the three-dimensional model 113). Specifically, the generation apparatus 1 may correct the inputted three-dimensional object information using a deep learning-based correction module (e.g. the module 100). For example, the correction module (e.g. the correction module 100) may be a deep learning module trained with learning data composed of three-dimensional skeleton information before correction, three-dimensional object information, and three-dimensional skeleton information after correction. The correction module (e.g. the correction module 100) according to this embodiment also has the same as or similar structure to the above-described conversion model 40 and may be implemented by being trained in the same or similar manner.

In some embodiments of the present disclosure, the generation apparatus 1 may determine the generation accuracy of the three-dimensional model and may perform correction step S380 in response to the determination that the determined accuracy is below a reference value. For example, the generation apparatus 1 may extract three-dimensional skeleton information from the three-dimensional model and may convert the three-dimensional skeleton information into two-dimensional skeleton information through a projection operation. In addition, the generation apparatus 1 may determine the generation accuracy of the three-dimensional model based on a difference between the converted two-dimensional skeleton information and the two-dimensional skeleton information extracted from the two-dimensional image. According to this embodiment, the computing cost inputted into the generation apparatus 1 may be reduced by performing the correction step S380 when the generation accuracy of the three-dimensional model is below the reference value.

The method of generating a 3-dimensional object model according to the third embodiment of the present disclosure has been described with reference to FIGS. 13 and 14. According to the above-described method, the three-dimensional model for the target object may be more elaborately generated by correcting the three-dimensional model using the object information extracted from the two-dimensional image, etc.

Hereinafter, an exemplary computing device 120 that can implement the generation apparatus 1 according to some embodiments of the present disclosure is described.

FIG. 15 illustrates an exemplary hardware configuration diagram of a computing device 120.

As shown in FIG. 15, the computing device 120 may include at least one processor 121, a bus 123, a communication interface 124, a memory 122 for loading a computer program executed by the processor 121 and a storage 125 for storing a computer program 126. However, FIG. 15 only shows components related to the embodiment of the present disclosure. Therefore, a person skilled in the art to which this disclosure pertains can recognize that other general-purpose components may be included in addition to the components shown in FIG. 15. That is, the computing device 120 may further include various components other than the components shown in FIG. 15. In some cases, the computing device 120 may be configured in the form where some of the components shown in FIG. 15 are omitted. Hereinafter, each component of the computing device 120 is described.

The processor 121 may control the overall operation of each component of the computing device 120. The processor 121 may include a Central Processing Unit (CPU), a Micro Processor Unit (MPU), a Micro Controller Unit (MCU), a Graphic Processing Unit (GPU) or at least one of any types of processors well-known in the art of this disclosure. In addition, the processor 121 may perform operations on at least one application or program to execute operations/methods according to embodiments of the present disclosure. The computing device 120 may include one or more processors.

Next, the memory 122 may store various data, instructions and/or information. The memory 122 may load one or more programs 126 from the storage 125 to execute operations/methods according to embodiments of the present disclosure. The memory 122 may be implemented as a volatile memory such as RAM, but the scope of the present disclosure is not limited thereto.

Next, the bus 123 may provide a communication function between components of the computing device 120. The bus 123 may be implemented as various types of buses such as an address bus, a data bus and a control bus.

Next, the communication interface 124 may support wired or wireless Internet communication of the computing device 120 addition, the communication interface 124 may support various communication methods other than Internet communication. For this, the communication interface 124 may include a communication module well-known in the technical field of the present disclosure. In some cases, the communication interface 124 may be omitted.

Next, the storage 125 may non-transitorily store one or more computer programs 126. The storage 125 may include a non-volatile memory such as Read Only Memory (ROM), Erasable Programmable ROM (EPROM), Electrically Erasable Programmable ROM (EEPROM) or a flash memory, a hard disk, a removable disk, or any type of computer-readable recording medium well-known in the art to which the present disclosure pertains.

Next, the computer program 126 may include one or more instructions that cause the processor 121 to perform operations/methods according to various embodiments of the present disclosure when loaded into the memory 122. That is, the processor 121 may perform operations/methods according to various embodiments of the present disclosure by executing one or more instructions.

For example, the computer program 126 may include instructions to perform a motion of acquiring the two-dimensional skeleton information extracted from the two-dimensional image of the target object, a motion of converting the two-dimensional skeleton information into three-dimensional skeleton information through a deep learning module and a motion of generating a three-dimensional model for the target object based on the three-dimensional skeleton information. In this case, the generation apparatus 1 according to some embodiments of the present disclosure may be implemented through the computing device 120.

The technical idea of the present disclosure explained with reference to FIGS. 1 to 15 may be implemented as computer-readable code on a computer-readable medium. The computer-readable recording medium is, for example, a removable recording medium (CD, DVD, Blu-ray disk, USB storage apparatus, removable hard disk), or a non-removable recording medium (ROM, RAM, computer-equipped hard disk). The computer program recorded on the computer-readable recording medium may be transmitted to another computing device through a network such as the Internet and installed on the other computing devices, and thus may be used in the other computing device.

Even though all the components constituting the embodiments of the present disclosure have been described as being combined into one or operated as one, the technical idea of the present disclosure is not necessarily limited to these embodiments. That is, all of the components may operate by selectively combining one or more of them within the scope of the purpose of the present disclosure.

Although operations are shown in the drawings in a specific order, it should not be understood that the operations must be performed in the specific order or sequential order shown or that all illustrated operations must be performed to obtain the desired results. In certain situations, multitasking and parallel processing may be advantageous. Moreover, the separation of the various components in the embodiments described above should not be understood as necessary, and it should be understood that the program components and systems described may generally be integrated together into a single software product or packaged into multiple software products.

Although embodiments of the present disclosure have been described with reference to the accompanying drawings, those skilled in the art will understand that the present disclosure can be easily changed or modified into other specified forms without change or modification of the technical spirit or essential characteristics of the present disclosure. Therefore, it should be understood that the aforementioned examples are only provided by way of example and not provided to limit the present disclosure. The protection scope of the present disclosure should be interpreted by the following claims, and all technical ideas within the equivalent scope should be interpreted as being included in the scope of rights of the technical ideas defined by the present disclosure.

1. An apparatus for generating a 3-dimensional object model, the apparatus comprising:
a memory for storing one or more instructions; and
a processor configured to execute the stored instructions to perform:
a motion of acquiring two-dimensional skeleton information extracted from a two-dimensional image of a target object;
a motion of converting the two-dimensional skeleton information into three-dimensional skeleton information through a deep learning module; and
a motion of generating a three-dimensional model for the target object based on the three-dimensional skeleton information.

2. The apparatus according to claim 1, wherein the deep learning module is a Graph Convolutional Networks (GCN)-based module, and comprises an encoder configured to receive the two-dimensional skeleton information and extract feature data; and a decoder configured to decode the extracted feature data and output the three-dimensional skeleton information.

3. The apparatus according to claim 2, wherein the encoder performs a down-sampling process to extract a plurality of feature data with different abstraction levels, and
the decoder performs an up-sampling process using the plural feature data.

4. The apparatus according to claim 1, wherein the processor further acquires another object information other than the two-dimensional skeleton information from the two-dimensional image, and
the converting motion comprises a motion of inputting the two-dimensional skeleton information and the other object information into the deep learning module and acquiring the three-dimensional skeleton information.

5. The apparatus according to claim 4, wherein the other object information comprises at least one of:
bone information comprising a bone length,
joint information comprising a joint angle, and
body part information comprising an area of a body part.

6. The apparatus according to claim 4, wherein the deep learning module comprises a first deep learning module for receiving first object information and a second deep learning module for receiving second object information among the additional object information, and
the acquiring motion comprises a motion of combining first skeleton information outputted through the first deep learning module and second skeleton information outputted through the second deep learning module to acquire the three-dimensional skeleton information.

7. The apparatus according to claim 1, wherein the deep learning module is trained based on an error between three-dimensional skeleton information predicted from two-dimensional skeleton information for learning and correct answer information, and
the error comprises at least one of an error in a center of weight, a bone length error and a joint angle error.

8. The apparatus according to claim 1, wherein the deep learning module is trained using two-dimensional skeleton information corrected based on domain information of an object,
the correcting comprises at least one of adding new connection lines between key points that make up a skeleton and strengthening connection lines, and
the domain is defined to be distinguished based on motion features of the object.

9. The apparatus according to claim 1, wherein two-dimensional skeleton information for learning of the deep learning module is generated by correcting a connection line between key points, based on a movement speed of the key points, with two-dimensional skeleton information extracted from consecutive frame images.

10. The apparatus according to claim 1, wherein the deep learning module is two or more, and
the converting motion comprises:
a motion of determining a deep learning module corresponding to a domain of the target object among the plural deep learning modules; and
a motion of converting the two-dimensional skeleton information into the three-dimensional skeleton information through the determined deep learning module,
wherein the domain is defined to be distinguished based on motion features of the object.

11. The apparatus according to claim 1, wherein the converting motion comprises a motion of inputting the two-dimensional skeleton information and domain information of the target object into the deep learning module to acquire the three-dimensional skeleton information,
wherein the domain is defined to be distinguished based on motion features of the object.

12. The apparatus according to claim 1, wherein the processor further acquires other object information, other than the two-dimensional skeleton information, from the two-dimensional image, and further performs a motion of correcting a three-dimensional model generated based on the other object information,
wherein the correcting motion comprises:
a motion of extracting three-dimensional skeleton information from the generated three-dimensional model;
a motion of correcting the extracted three-dimensional skeleton information according to the other object information; and
a motion of re-generating a three-dimensional model for the target object based on the corrected three-dimensional skeleton information.

13. A method of generating a 3-dimensional object model, wherein the method is performed in a computing device, and
the method comprises:
acquiring two-dimensional skeleton information extracted from a two-dimensional image of a target object;
converting the two-dimensional skeleton information into three-dimensional skeleton information through a deep learning module; and
generating a three-dimensional model for the target object based on the three-dimensional skeleton information.

14. A computer program, wherein the computer program is combined with a computing device, and stored in a computer-readable recording medium to acquire two-dimensional skeleton information extracted from a two-dimensional image of a target object; to convert the two-dimensional skeleton information into three-dimensional skeleton information through a deep learning module; and to generate a three-dimensional model for the target object based on the three-dimensional skeleton information.
